(19) United States
(12) Patent Application Publication
(10) Pub. No.: US 2026/0141008 A1
(43) Pub. Date: May 21, 2026

(54) SYSTEMS AND METHODS FOR IDENTIFYING A SEED SET OF DOCUMENTS FROM A CORPUS OF DOCUMENTS

(71) Applicant: RELATIVITY ODA LLC, Chicago, IL (US)

(72) Inventors: Nathan Reff, Rochester, NY (US); Aron Ahmadia, Arlington, VA (US); Evan M. Curtin, Brooklyn, NY (US)

(21) Appl. No.: 19/386,999

(22) Filed: Nov. 12, 2025

Related U.S. Application Data
(60) Provisional application No. 63/722,310, filed on Nov. 19, 2024.

(51) Int. Cl. G06F 16/953

(52) U.S. Cl. CPC G06F 16/953

(57) ABSTRACT

A system may obtain background documents and a case context extraction prompt and generate case context data by analyzing the background documents via a case context machine learning model. The case context prompt is input into the case context machine learning model with the background documents to cause the case context machine learning model to output the case context data and controls how the case context machine learning model analyzes the background documents to identify key concepts therein. The case context data includes the identified key concepts. The system may generate search queries based on the key concepts, query, via a document search engine, a corpus of documents using the search queries to produce sets of ranked documents for the search queries, compile a seed set of documents from the sets of ranked documents, and provide the seed set of documents to a document review application executing within a workspace.

### CROSS-REFERENCE TO RELATED APPLICATIONS

This application claims priority to U.S. Patent Application No. 63/722,310, entitled “Systems and Methods for Identifying a seed set of documents from a Corpus of Documents” (filed Nov. 19, 2024), the entire contents of which are hereby incorporated by reference.

### FIELD

The present disclosure generally relates to computer systems for processing, managing, and analyzing a corpus of electronic documents and, more particularly, to systems and methods for identifying a seed set of documents from a corpus of documents.

### BACKGROUND

Document management and analysis tools are important systems for identifying useful material from large otherwise unwieldy sets of electronic documents. In particular, the extreme increase in document generation produced by the advent and widespread adoption of electronic devices (computers, smart phones, tablets, etc.) and electronic software tools (email, digital chat, word processing, etc.) has made prior methods of manual document review and analysis impractical. However, the current tools for managing and analyzing a large corpus of documents rely on combinations of generic search algorithms and user inputs with respect to the whole corpus of documents to identify relevant or otherwise important documents included in the corpus of documents. As a result, the conventional tools are unable to quickly and productively identify important or relevant documents and in some case may result in key documents being missed altogether.

Accordingly, there is a need for systems and methods that can automatically analyses and process a corpus of documents to identify a seed set of documents, which can then be utilized with a document review application to identify relevant or key documents in the corpus of electronic documents in a quicker and more accurate manner than possible using currently existing tools.

### SUMMARY

In some aspects, the techniques described herein relate to a computer system including: one or more processors; and one or more non-transitory, computer-readable media storing instructions that, when executed by the one or more processors, cause the computer system to: obtain one or more background documents for a matter and a case context extraction prompt; generate case context data by analyzing the one or more background documents via a case context machine learning model, wherein: the case context extraction prompt is input into the case context machine learning model with the one or more background documents to cause the case context machine learning model to output the case context data, the case context extraction prompt controls how the case context machine learning model analyzes the one or more background documents to identify key concepts therein, and the case context data includes the identified key concepts; generate a set of search queries based on the key concepts; query, via a document search engine, a corpus of documents using the set of search queries to produce respective sets of ranked documents for each query in the set of search queries; compile a seed set of documents from the respective sets of ranked documents for each query in the set of search queries; and provide the seed set of documents to a document review application executing within a workspace.

In some aspects, the techniques described herein relate to a computer-implemented method including: obtaining one or more background documents for a matter and a case context extraction prompt; generating case context data by analyzing the one or more background documents via a case context machine learning model, wherein: the case context extraction prompt is input into the case context machine learning model with the one or more background documents to cause the case context machine learning model to output the case context data, the case context extraction prompt controls how the case context machine learning model analyzes the one or more background documents to identify key concepts therein, and the case context data includes the identified key concepts; generating a set of search queries from the key concepts included in the case context data output from the case context machine learning model; querying, via a document search engine, a corpus of documents using the set of search queries to produce respective sets of ranked documents for each query in the set of search queries; compiling a seed set of documents from the respective sets of ranked documents for each query in the set of search queries; and providing the seed set of documents to a document review application executing within a workspace.

In some aspects, the techniques described herein relate to a non-transitory machine-readable medium comprising a plurality of machine-readable instructions that when executed by one or more processors are adapted to cause the one or more processors to: obtain one or more background documents for a matter and a case context extraction prompt; generate case context data by analyzing the one or more background documents via a case context machine learning model, wherein: the case context extraction prompt is input into the case context machine learning model with the one or more background documents to cause the case context machine learning model to output the case context data, the case context extraction prompt controls how the case context machine learning model analyzes the one or more background documents to identify key concepts therein, and the case context data includes the identified key concepts; generate a set of search queries from the key concepts included in the case context data output from the case context machine learning model; query, via a document search engine, a corpus of documents using the set of search queries to produce respective sets of ranked documents for each query in the set of search queries;
compile a seed set of documents from the respective sets of ranked documents for each query in the set of search queries; and
   provide the seed set of documents to a document review application executing within a workspace

### BRIEF DESCRIPTION OF THE DRAWINGS

FIG. 1 is a block diagram of a computing environment in accordance with one or more embodiments.

FIG. 2 is a schematic document of case context data generated using modules of the computing environment of FIG. 1.

FIG. 3 is a partial details block diagram of identifying a seed set of documents using the computing environment of FIG. 1 in accordance with one or more embodiments.

FIG. 4 is a flow diagram of a method in accordance with one or more embodiments.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

The systems and methods described herein relate to new systems and methods for processing, managing, and analyzing a corpus of electronic documents. In particular, the systems and methods described herein describe systems and methods for identifying a seed set of documents from among the corpus of documents using key matter concepts derived from case context data that is automatically generated from one or more background documents in the corpus of documents. As described herein, artificial intelligence (AI) and/or machine learning (ML) models are used to generate the case context data.

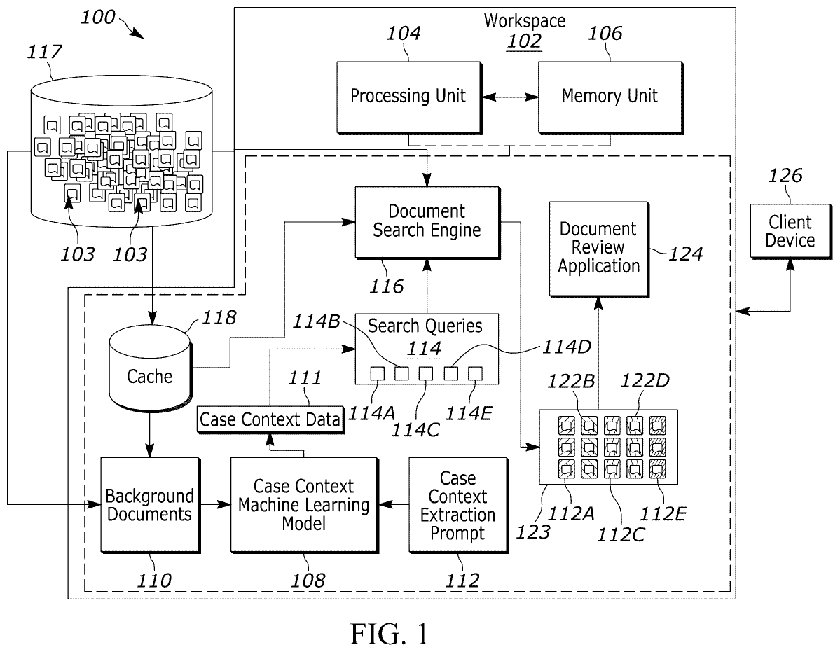

With reference now to FIG. 1 a computing environment 100 for identifying a seed set of documents is shown. The computing environment 100 includes a workspace 102. The workspace 102 may be associated with a corpus of documents 103, such as a set of documents associated with an eDiscovery project. Documents in the corpus of documents 103 may be in various types of files (e.g., an email file, a word processing file, a spreadsheet file, an audio recording file, imagery data file (e.g., image and/or video data), a text message or other group communication file, etc.

The workspace 102 and/or the components thereof may be implemented as software or hardware modules within a cloud and/or distributed computing system (e.g., Amazon Web Services (AWS) or Microsoft Azure). Accordingly, the components of the workspace 102 may include separate logical addresses via which the components are accessible via a bus or other messaging channel supported by the cloud computing system. In some embodiments, the workspace 102 includes multiple instances of the same component to increase the ability the parallelization for the various functions performed via the respective components.

A processing unit 104 and a memory unit 106 may implement the computing environment 100 and the workspace 102. More particularly, the processing unit 104 and the memory unit 106 may comprise portions of cloud and/or distributed computing system that implements the workspace 102. Processing unit 104 includes one or more processors, each of which may be a programmable microprocessor that executes software instructions stored in memory unit 106 to execute some or all of the functions of workspace 102 as described herein. Processing unit 104 may include one or more graphics processing units (GPUs) and/or one or more central processing units (CPUs), for example. Alternatively, or in addition, one or more processors in processing unit 104 may be other types of processors (e.g., application-specific integrated circuits (ASICs), field-programmable gate arrays (FPGAs), etc.), and some of the functionality of workspace 102 as described herein may instead be implemented in hardware. Memory unit 106 may include one or more volatile and/or non-volatile memories or similar computer readable media. Any suitable memory type or types may be included in memory unit 106, such as read-only memory (ROM) and/or random-access memory (RAM), flash memory, a solid-state drive (SSD), a hard disk drive (HDD), and so on. Collectively, memory unit 106 may store one or more software applications, the data received/used by those applications, and the data output/generated by those applications.

In particular, memory unit 106 stores the software that, when executed by processing unit 104, perform various functions of the computing environment 100 related to execution of a case context machine learning model 108 to identify, extract, and/or generate case context data 111 from background documents 110 as directed by a case context extraction prompt 112. In general, the memory unit 106 also stores software that generates search queries 114 from the case context data 111 output from the case context machine learning model 108 and executes a document search engine 116 that performs the search queries 114.

As shown in FIG. 1, the corpus of documents 103 is accessible via the workspace 102. The corpus of documents 103 may include a set of electronic documents (digitized paper documents, electronically generated documents, documents exported from user devices, etc.) that have been ingested into the workspace 102. In some embodiments, the corpus of documents 103 relates to a matter being processed, managed, or analyzed by the computing environment 100 (e.g., a litigation, a discovery request, a research project, etc.). Initially, the processing unit 104 ingests each document in the corpus of documents 103 such that they are accessible by the workspace 102. This ingestion pipeline includes the processing unit 104 assigning each document a unique identifier and performing other pre-processing tasks such as performing optical character recognition (OCR), metadata extraction or processing, etc.

In the illustrated embodiment, the processing unit 104 maintains the corpus of documents 103 at a data store 117 after ingestion. The data store 117 may be implemented as a database, data lake, memory, or other digital storage medium known in the art. Accordingly, the data store 117 may be a file system data store, an object-based data store, or other type of data store utilized in the art. Depending on the embodiment, the data store 117 may be implemented locally at the workspace 102, externally at an external data storage service, or a combination thereof. The workspace 102, via the processing unit 104, may be in wired or wireless communication with the external data storage service. In some embodiments, the processing unit 104 may load the corpus of documents 103 into a local cache 118 for processing by one or more applications executing in the workspace 102 (such as the document search engine 116 and the case context machine learning model 108).

As illustrated, the processing unit 104 may select the background documents 110 for analysis to derive the case context data 111. More particularly, the processing unit 104 may identify and select the background documents 110 based on metadata, keywords, document titles, etc. that distinguish the background documents 110 from other documents in the corpus of documents 103. In some embodiments, the metadata, keywords, document titles, etc. may be manually added via user input received by the workspace 102. The background documents 110 may include specific document types that are regularly generated at the initial stage of a matter. For example, when the matter relates to a lawsuit, the background documents 110 may include initial filing or prefiling materials (pre-suite demand letters, plaintiff complaint, defendant response, etc.). In some embodiments, the background documents 110 may not be included within the corpus of documents 103. In these embodiments the corpus of documents 103 may be limited to specific types of documents that are distinct from the background documents 110. For example, the corpus of documents 103 may exclude court orders and related documents and be otherwise limited to documents collected from one or more electronic devices of a party to a litigation.

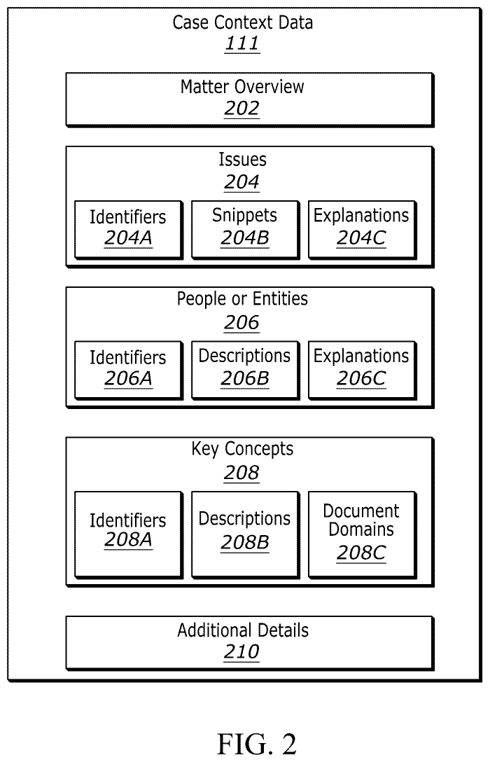

The case context machine learning model 108 may analyze the background documents 110 to output case context data. For example, the case context data may include key concepts (e.g., key concepts 208 shown in FIG. 2) derived from the background documents 110. The case context machine learning model 108 comprises a set of interconnected nodes, layers, trained parameter values (e.g., multiplicative weights, additive bias, etc.), etc. The trained parameters are set via backpropagation or other similar techniques in a training process that uses historical data inputs to identify or recognize patterns and trends therein. Various architectures for the case context machine learning model 108 are possible, including, but not limited to, convolutional neural network (CNN) architectures, transformer architectures, recurrent/recursive neural network (RNN) architectures, sorting/clustering architectures, etc. In some embodiments, the case context machine learning model 108 includes a large language model (LLM). The LLM can be a model trained by a third party and accessed by the workspace 102 via an application programming interface (API). The LLM can also be a fine-tuned public model (e.g., a model that is initially trained on publicly available or third-party data and tuned using private/proprietary data accessible by the workspace 102) or a full privately trained model managed by the workspace 102 (e.g., a model that is fully trained by the workspace 102 on private/proprietary data and/public data accessible thereto).

The processing unit 104 may input the case context extraction prompt 112 and the background documents 110 into the case context machine learning model 108 to generate the case context data 111. The case context extraction prompt 112 and the background documents 110 may be a single set of inputs simultaneously input into the case context machine learning model 108 or a sequenced set of inputs sequentially input into the case context machine learning model 108. For example, the processing unit 104 may combine the background documents 110 with the case context extraction prompt 112 by appending the raw text of the background documents 110 together with the fact case context extraction prompt 112 or by appending a document reference marker to the fact case context extraction prompt 112 that the case context machine learning model 108 may use to recall the background documents 110 from the data store 117 or local cache 118.

The case context extraction prompt 112 is configured to control how the case context machine learning model 108 analyzes content of the background documents 110 to identify and output the case context data 111 and the key concepts included therein (e.g., the key concepts 208 shown in FIG. 2). The case context extraction prompt 112 may include definitions for the key concepts 208, locations where the key concepts 208 are likely to occur in the background documents 110, rules for structuring a format of the key concepts 208 within the output case context data, and other instructions or rules as described herein. Additional details of the case context extraction prompt 112 are discussed herein in relation to FIG. 2.

As shown in FIG. 1, the processing unit 104 may generate the search queries 114 from the case context data 111. In some embodiments, the processing unit 104 may generate the search queries 114 using the key concepts (e.g., the key concepts 208) included in the case context data 111. Additionally or alternatively, the processing unit 104 may generate the search queries 114 by extracting natural language queries and/or search terms from the case context data 111. The case context machine learning model 108 may generate the natural language queries and/or search terms using rules included in the case context extraction prompt 112. In any case, the search queries 114 may include a set of queries formed from individual queries 114A, 114B, 114C, 114D, 114E, etc. Each individual query 114A, 114B, 114C, 114D, 114E, etc. may relate to one of the key concepts (e.g., the key concepts 208), natural language queries, and/or search terms included in the case context data 111.

As shown in FIG. 1, the processing unit 104 queries, via the document search engine 116, the corpus of documents 103 using each individual query 114A, 114B, 114C, 114D, 114E, etc. of the search queries 114. The document search engine 116 may return ranked documents 122 in response to receiving the search queries 114. The ranked documents 122 may include document sets 122A, 122B, 122C, 122D, 122E, etc. that are respectively associated with each individual query 114A, 114B, 114C, 114D, 114E, etc. of the search queries 114. The document sets 122 may be ranked based on any suitable search result ranking technique (e.g., similarity, relevance, etc.) based on the respective query 114. When ranking documents based on a search query 114, the document search engine 116 may be configured to apply the ranking technique to the contents and/or the metadata of the documents in the corpus of documents 103. It should also be appreciated that some documents may appear in multiple document sets 122A, 122B, 122C, 122D, 122E, etc. For example, a single document may both be a highly-ranked document in both the set 122A and the set 122D. Furthermore, it should be appreciated that output of the search engine 116 may include reference markers (e.g., document identifiers, etc.) for each document in the ranked document 122 rather than copies of the documents.

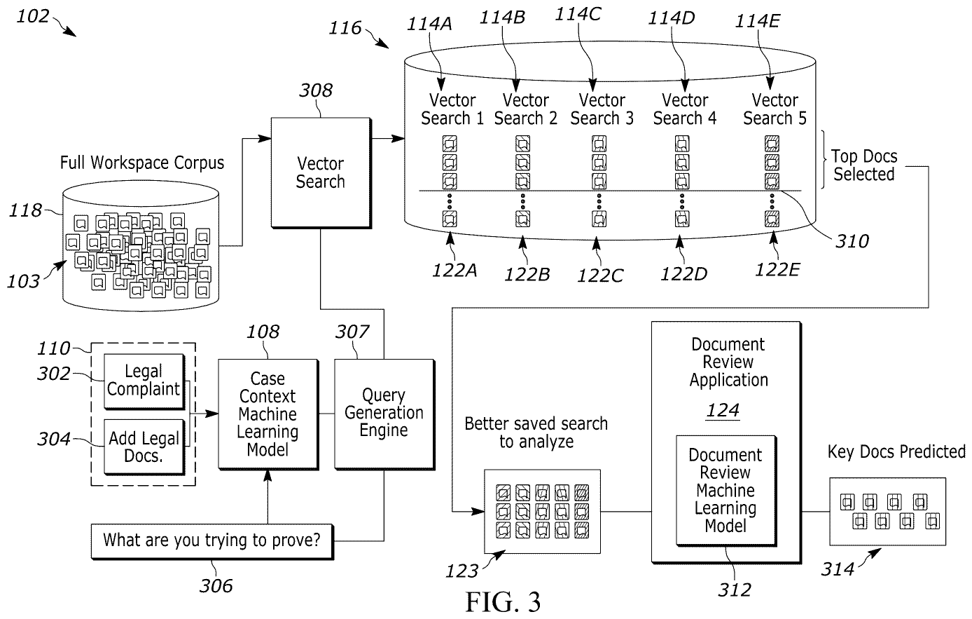

The document search engine 116 shown in FIG. 1 may include various types of search engines known in the art. For example, the document search engine 116 may include a vector search engine (see e.g., vector search engine 308 of FIG. 3) that ranks vectorized versions of the corpus of documents 103 by similarity between the vectorized documents and vectorized search queries (e.g., the search queries 114). For example, similarity may be determined based on a Euclidean distance, based on a distance within a feature space in which the multi-dimensional vectors are projected, etc. In these embodiments, the search engine 116 may first build a search index by performing a predefined set of operations on the documents in the corpus of documents 103 to generate the corresponding vectorized versions of the documents. In some embodiments, the search engine 116 may divide the documents into discrete chunks using various chunking techniques (e.g., by paragraph, by page, by word count, etc.). The search engine 116 may then vectorize the document chunks using the same predetermined set of operations for inclusion in the search index. Accordingly, when a query of the search index is performed, the search engine is able to identify particular sections of the document that are relevant to the query. It should be appreciated that other search techniques may be implemented instead of the vector search engine (e.g., keyword search, Boolean search, and any combination thereof (including combinations with the vector search engine)).

In other embodiments, the document search engine 116 may include a large language machine learning model or a large multimodal machine learning model.

After the document search engine 116 returns the document sets 122A, 122B, 122C, 122D, 122E, etc., the processing unit 104 may compile the document sets 122A, 122B, 122C, 122D, 122E, etc. into a seed set of documents 123. The processing unit 104 may store the seed set of documents 123 in the data store 117 and/or the local cache 118 for use by a document review application 124 executing within the workspace 102. Furthermore, in embodiments where the output of the search engine 116 includes the reference markers for the ranked documents 122, the seed set of documents 123 may also include a set of the reference markers instead of copies of each document. In some embodiments, the processing unit 104 may include additional documents besides the document sets 122A, 122B, 122C, 122D, 122E, etc. in the compiled seed set of documents 123. For example, the processing unit 104 may use a diversity or random document sampler to identify additional diverse or random documents that do not rank highly in response to the search queries 114 to include in the seed set of documents 123. These types of documents makes the seed set of documents 123 more robust as a training set by additionally including examples of nonrepresentative documents for training. As one example, the document sets 122A, 122B, 122C, 122D, 122E, etc. may include the top 50 results for the relevant search queries 114 and an additional 20 documents selected using diversity and/or random selection.

As shown in FIG. 1, the computing environment 100 may be communicably coupled to a client device 126 operated by a user (a personal computer, mobile phone, tablet, or other suitable type of personal electronic device). The client device 126 may be operatively coupled to the workspace 102 via wired or wireless means known in the art. The client device 126 may execute an application (e.g., a browser or a dedicated application) via which the client device 126 interfaces with the workspace 102.

As one example, the client device 126 may interact with a document review application 124 to generate and/or review the seed set of documents 123. For example, the review application 124 may provide a user interface via which the user is able to initiate the process of generating the seed set of documents 123 in accordance with the above-described techniques. After the seed set of documents 123 are generated, the document review application 124 may enable the user to review, modify, or otherwise interact with the seed set of documents 123 prior to initiating a document review process that utilizes the seed set of documents 123.

Furthermore, the seed set of documents 123 may be used as part of a training process for a classifier model that classifies the documents in the corpus of documents 103. For some classifier models (e.g., a support vector machines model of a prioritized review process), the document review application 124, the processing unit 104, or other module of the workspace 102 may train the classifier model using manually-applied labels to the seed set of documents 123 so that the model starts with consuming knowledge of particularly relevant matter issues (e.g., issues 204 of FIG. 2). For some other classifier models (e.g., those that implement a prompt engineering approach), the seed set of documents 123 may be used as a validation data set via which classification performance of the classification model is assessed. Regardless, the seed set of documents 123 may generally include a set of documents that are representative of all the relevant matter issues. To accomplish this representative distribution, the case context extraction prompt 112 may include instructions to generate or identify the key concepts 208 (see FIG. 2) based on the relevant matter issues (e.g., issues 204 of FIG. 2).

FIG. 2 shows a schematic diagram of the case context data 111 generated by the case context machine learning model 108 as directed by the case context extraction prompt 112. As shown in FIG. 2, the case context data 111 may include sections relating to a matter overview 202, the issues 204, people or entities 206, the key concepts 208, and additional details 210. Each of these sections may be generated by the case context machine learning model 108 from one or more corresponding rules included in the case context extraction prompt 112.

The matter overview 202 may comprise a text summary detailing general features of the matter such as background on key entities and people, substantive allegations being made in relation to the matter, known relevant dates, etc. To generate the matter overview 202, associated matter overview rules in the case context extraction prompt 112 may direct the case context machine learning model 108 to generate a summary of the background documents 110.

The issues 204 may include a specific listing of different issue areas relevant to the matter. To generate the issues 204, associated issue rules in the case context extraction prompt 112 may direct the case context machine learning model 108 to identify portions of the background documents 110 that relate to or define the issues areas relevant to the matter. For example, the issue rules may direct the case context machine learning model 108 to detect a statutory basis for the matter to identify issues commonly associated therewith. As shown in FIG. 2, the issues 204 may include fields defining the issue, such as identifiers 204A (e.g., titles, names, etc., for the issue), snippets 204B (e.g., passages extracted from the background documents 110 related to the issue), and explanations 204C (e.g., text explaining why the issue is relevant).

To generate the identifiers 204A, the case context extraction prompt 112 may include instructions that explicitly direct the case context machine learning model 108 to generate the identifiers 204A (e.g., sequentially, based on the text of the background documents 110, etc.). To generate the snippets 204B, the case context extraction prompt 112 may include instructions that explicitly direct the case context machine learning model 108 to identify and extract representative text from the background documents 110. To generate the explanations 204C, the case context extraction prompt 112 may include explicit instructions that direct the case context machine learning model 108 to (1) describe why the identified one of the issues 204 makes sense based on content of the background documents 110 and/or (2) provide additional context that supports the one of the issues 204. In some embodiments, the associated explanations 204C may include a definition of the associated one of the issues 204 that may be used by other modules of the workspace 102 to identify documents and/or portions thereof that are relevant to the issues 204.

In some embodiments, the issues 204 may also include user defined issues that are not automatically identified by the case context machine learning model 108 from the background documents 110. For example, the issues 204 may additionally or alternatively include a list of issues identified directly by an opposing party in litigation or a list of issues identified from a document production or similar request from the opposing party. Furthermore, the issues 204 may include issues identified independent of opposing party requests or such as issues identified from initial user review of the corpus of documents 103 and/or predictions of issues that may be identified from further manual or analysis of the corpus of documents 103.

In some embodiments, the user defined issues may be input into the case context machine learning model 108 along with the background documents 110 and the case context extraction prompt 112. In these embodiments, the case context extraction prompt 112 may include instructions that direct the case context machine learning model 108 to generate identifiers 204A, snippets 204B, and explanations 204C that are associated with the user defined issues.

As illustrated, the extracted case context data 111 also includes the people or entities 206. The people or entities 206 may include text data that identify particular persons or legal entities involved with the matter. To generate the people or entities 206, associated people or entity rules in the case context extraction prompt 112 may direct the case context machine learning model 108 to identify portions of the background documents 110 that relate to people or entities. For example, in some embodiments, the people or entity rules may include location details that describe areas of the background documents 110 that will be likely to include details on the people or entities 206. Such locations may include a caption, a listing of parties, a title page, a signature page, etc.

Similar to the issues 204, the people or entities 206 may also include fields defining the person or entity, such as identifiers 206A (e.g., titles, names, etc., for each distinct person or entity), descriptions 206B (e.g., text that provides details about the associated person or entity), and explanations 206C (e.g., a justification or reason for defining the person or entity). To generate the identifiers 206A, the case context extraction prompt 112 may include instructions that explicitly direct the case context machine learning model 108 to generate the identifiers 206A (e.g., sequentially, based on the text of the background documents 110, etc.). To generate the descriptions 206B, the case context extraction prompt 112 may include instructions that explicitly direct the case context machine learning model 108 to generate the text for the associated description 206B (e.g., by extracting knowledge from the background documents). To generate the explanations 206C, the case context extraction prompt 112 may include explicit instructions that direct the case context machine learning model 108 to (1) describe why the identified person or entity of the of the people or entities 206 makes sense based on content of the background documents 110 and/or (2) provide additional context that supports inclusion of the person or entity in the people or entities 206.

As illustrated, the extracted case context data 111 includes the key concepts 208. The key concepts 208 may include text data that generally indicates types of material to look for in the corpus of documents 103. Furthermore, as described above the key concepts 208 may include material that relates to or is based on one or more of the issues 204 so that the seed set of documents 123 identified by the processing unit 104 are representative of the issues 204. Generating separate entries for the issues 204 and the key concepts 208 may allow the processing unit 104 to format each of the issues 204 and the key concepts 208 differently based on particular use cases within the workspace 102. For example, the case context extraction prompt 112 may direct the case context machine learning model 108 to format the key concepts 208 such that the processing unit 104 may efficiently generate the search queries 114 therefrom. The key concepts 208 may also include material that relates to the people or entities 206. To generate the key concepts 208, key concept rules in the case context extraction prompt 112 may direct the case context machine learning model 108 to generate the key concepts 208 based on the issues 204, the people or entities 206, and/or other contents of the background documents 110.

As shown in FIG. 2, the key concepts 208 may include fields defining the key concept, such as identifiers 208A (e.g., titles, names, etc., for each distinct concept), descriptions 208B (e.g., text that provides details about the associated concept), document domains 208C (e.g., text that indicates the types of documents that are likely to include material related to the associated concept). To generate the identifiers 208A, the case context extraction prompt 112 may include instruction that explicitly direct the case context machine learning model 108 to generate the identifiers 208A (e.g., sequentially, based on the text of the background documents 110, etc.). To generate the descriptions 208B, the case context extraction prompt 112 may include instructions that explicitly direct the case context machine learning model 108 to generate the text for the associated description 208B (e.g., by extracting knowledge from the background documents). To generate the document domains 208C case context extraction prompt 112 may include explicit instructions that directs the case context machine learning model 108 to generate a list of document types related to the associated concept (e.g., contracts, licensing agreements, internal communications, external communications, research papers, corporate communications, etc.)

The additional details 210 of the case context data 111 may include other information extracted from the background documents 110, such as a detailed summary of matter, a list of other important documents mentioned in the background documents 110, key matter terms, descriptions of responsive and non-responsive document categories or types, details on privilege issues (e.g., indications of possible disputes, waivers, etc.), etc. The detailed summary may include text summarizing plaintiff allegations, defendant defenses and response, an initial rough timeline of the matter, plaintiff demands, requested damages, a list of case citations, notations of explicit admissions or denials, a summary of standing claims, and/or a list of prior related proceedings. The case context extraction prompt 112 may include rules that direct the processing unit 104 to identify each element of the additional details 210 for inclusion in the case context data 111.

As described above, the processing unit 104 may process the case context data 111 to generate the search queries 114. More particularly, the processing unit 104 may analyze the key concepts 208 included in the case context data 111 to define the search queries 114 that likely identify information that is particularly relevant to the matter. For example, a search query 114 may include text derived from the description 208B and/or search parameters based on the document domains 208C. Accordingly, when the document search engine 116 performs a query, the search engine 116 may first filter the search index to isolate those documents (or chunks thereof) using the search parameters before ranking the remaining documents using a similarity metric.

It should be appreciated that in some embodiments, the processing unit 104 may be configured to process other aspects of the case context data 111 (e.g., the issues 204, the people or entities 206, the additional details 210, etc.) to generate the search queries 114 in addition or as an alternative to processing the key concepts 208. For example, in some embodiments, the processing unit 104 may generate the search queries 114 from the issues 204.

With reference now to FIG. 3, additional features of the modules of the workspace 102 shown in FIG. 1 will be described in more detail. As shown in FIG. 3, the background documents 110 may include particular documents relating to initiation of a legal matter such as a legal complaint filing 302 and additional legal documents 304. The additional legal documents 304 may include documents such as pre-litigation demand letters and responses, a defendant's answer, motions to dismiss, related litigation documents, etc.

As shown in FIG. 3, the processing unit 104 may receive user input indicating an analysis objective 306 for the matter. In general, the analysis objective 306 may be an optional input that indicates one or more arguments related to the matter associated with the corpus of documents 103. These one or more arguments, when included, provide specific context for modules of the workspace 102 to use when generating case context data 111, generating the search queries 114, or searching the corpus of documents 103 to identify the seed set of documents 123. In particular, the processing unit 104 may input the analysis objective 306 into the case context machine learning model 108 for use in generating the case context data 111. In these embodiments, rules in the case context extraction prompt 112 may direct the case context machine learning model 108 to refence the analysis objective 306 when generating any portion of the case context data 111 as described herein (e.g., the matter overview 202, the issues 204, the people or entities 206, the key concepts 208, or the additional details 210).

As shown in, FIG. 3, in some embodiments, the workspace 102 may include a query generation engine 307. The processing unit 104 may invoke the query generation engine 307 to generate the search queries 114 from the case context data 111 and, if provided, the analysis objective 306. The query generation engine 307 may be configured to extract the relevant portions of the case context data 111, such as the key concepts 208, and modify the relevant portions into the search queries 114, such as by formatting the relevant portions into a data format used by the document search engine 116. For example, when the document search engine 116 includes the vector search engine 308 the query generation engine 307 may convert the key concepts 208, the analysis objective 306, or other inputs used to construct the search queries 114 into multi-dimensional vectors useable by the vector search engine 308. Additionally, in embodiments where the document search engine 116 includes an LLM or LMM, the query generation engine 307 may convert the key concepts 208, the analysis objective 306, or other inputs used to construct the search queries 114 into a prompt or other input of the LLM or LMM. It should be appreciated that other model types for the document search engine 116 are envisioned. For example, the document search engine 116 may be configured to implement additional search techniques such as re-ranking, hybrid search, etc.

As shown in FIG. 3, when compiling the ranked documents 122 into the seed set of documents 123, the processing unit 104 may select a predetermined number 310 of the ranked documents 122 returned for each of the queries 114A, 114B, 114C, 114D, 114E, etc. for including in the seed set of documents 123. While FIG. 3 depicts that the “top” documents are selected for the seed set of documents 123, in some embodiments, other selection techniques may be applied (e.g., random sampling, etc.). The predetermined number 310 may be set by user input received by the workspace 102 such as from the client device 126.

It should be appreciated that while FIG. 3 depicts the vector search engine 308, the vector search queries 114, and the ranked documents 122, in other embodiments similar techniques may be applied to generate alternative types of search queries and/or search results. For example, in an alternate embodiment, the query generation engine 307 may generate Boolean and/or keyword search queries (e.g., by identifying key phrases and/or entities in the case context data). In these examples, the search results 114 not be ranked. Accordingly, the processing unit 104 may include a random selection of matched documents in the seed set of documents 123. Additionally or alternatively, the query generation engine 307 may also combine vector search techniques with keyword and/or Boolean search techniques to still generate ranked results while applying keyword and/or Boolean search techniques.

As shown in FIG. 3, in some embodiments the document review application 124 may include a document review machine learning model 312. In these embodiments, the document review application 124 is configured to input the seed set of documents 123 into the document review machine learning model 312 to identify documents that satisfy the analysis objective (e.g., identifying relevant documents, identifying privileged documents, etc.). Additional details on the document review application 124 and document review machine learning model 312 are shown and described in U.S. Provisional Application 63/702,637 filed Oct. 2, 2024, the entire disclosure of which is hereby incorporated by reference.

In some embodiments, the processing unit 104 may receive feedback on various outputs generated using the modules of the workspace 102. This feedback may be on the accuracy of the rankings applied to ranked documents 122 within the seed set of documents 123, the key concepts 208 included in the case context data 111 by the case context machine learning model 108, other portions of the case context data 111 generated by the case context machine learning model 108, the search queries 114 generated by the query generation engine 307, and/or the set of key documents 314 identified by the document review machine learning model 312. In response to this feedback, the processing unit 104 may update the case context extraction prompt 112 or one or more parameters of the case context machine learning model 108 based on the feedback.

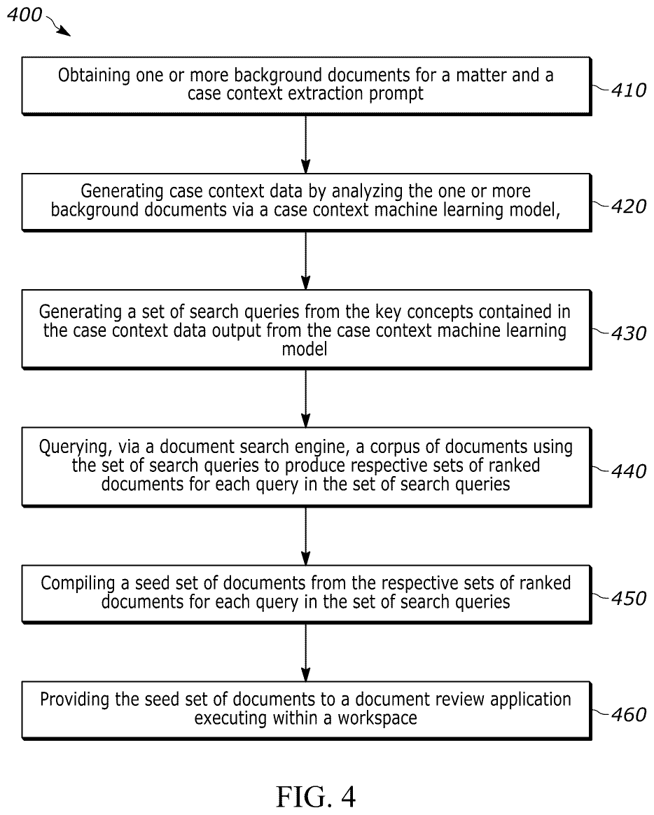

FIG. 4 shows a computer-implemented method 400 for using the case context machine learning model 108 and the document search engine 116 to generate the seed set of documents 123. The method 400 may be performed by the processing unit 104 executing instructions stored on the memory unit 106 to support the various modules described herein that are executed within the workspace 102.

At block 410, the method 400 includes obtaining one or more background documents (e.g., background documents 110) for a matter and a case context extraction prompt (e.g., case context extraction prompt 112).

At block 420, the method 400 includes generating case context data (e.g., case context data 111) by analyzing the one or more background documents via a case context machine learning model (e.g., case context machine learning model 108). The case context prompt is input into the case context machine learning model with the one or more background documents to cause the case context machine learning model to output the case context data. The case context prompt controls how the case context machine learning model analyzes the one or more background documents to identify key concepts (e.g., key concepts 208) therein. The case context data includes the identified key concepts. The case context extraction prompt may include definitions for the key concepts, locations where the key concepts are likely to occur in the one or more background documents, or rules for structuring an output format of the key concepts. The case context data may include one or more of an overview of the matter, issues present in the matter, people relevant to the matter, or relevant entities related to the matter. In some embodiments, to generate the case context data, the method 400 includes receiving user input indicating an analysis objective for the matter and updating the case context prompt to include an indication of the analysis objective.

At block 430, the method 400 includes generating a set of search queries (e.g., search queries 114) from the key concepts included in the case context data output from the case context machine learning model. The set of search queries generated from the key concepts included in the case context data may include multi-dimensional vectors and the document search engine may include a vector search engine that ranks vectorized versions of the corpus of documents by similarity to each of the multi-dimensional vectors. The document search engine may also comprises a large language machine learning model or a large multimodal machine learning model and the set of search queries comprise at least a portion of an input prompt for the large language machine learning model. In some embodiments, the method 400 may include generating the set of search queries by inputting the case context data output from the case context machine learning model into a query generation engine. In some embodiments, the method 400 includes receiving user input indicating an analysis objective for the matter and generating the set of search queries from the case context data and the analysis objective.

At block 440, the method 400 includes querying, via a document search engine (e.g., document search engine 116), a corpus of documents (e.g., corpus of documents 103), using the set of search queries to produce respective sets of ranked documents (e.g., document sets 122A, 122B, 122C, 122D, 122E, etc.) for each query (e.g., individual queries 114A, 114B, 114C, 114D, 114E, etc.) in the set of search queries. The document search engine may be configured to search contents of the corpus of matter related documents for matches to the set of search queries. The document search engine may also be configured to search metadata of the corpus of matter related documents for matches to the set of search queries.

At block 450, the method 400 includes compiling a seed set of documents (e.g., seed set of documents 123) from the respective sets of ranked documents for each query in the set of search queries. The seed set of documents may include a predetermined number of the set of ranked documents for each query in the set of search queries.

At block 460, the method 400 includes providing the seed set of documents to a document review application (e.g., document review application 124) executing within a workspace (e.g., workspace 102). The document review application may be configured to input the seed set of documents into a document review machine learning model to identify a set of key documents from among the corpus of documents.

The method 400 may include receiving feedback on accuracy of the rankings applied to respective sets of ranked documents and updating the case context extraction prompt or one or more parameters of the case context machine learning model based on the feedback. The method 400 may also include receiving feedback on the key concepts included in the case context data output from the case context machine learning model and updating case context extraction prompt or one or more parameters of the case context machine learning model based on the feedback.

It is understood that the blocks of the method 400 need not occur strictly in the order shown.

### OTHER MATTERS

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer system comprising:
one or more processors; and
one or more non-transitory, computer-readable media storing instructions that, when executed by the one or more processors, cause the computer system to:
obtain one or more background documents for a matter and a case context extraction prompt;
generate case context data by analyzing the one or more background documents via a case context machine learning model, wherein:
the case context extraction prompt is input into the case context machine learning model with the one or more background documents to cause the case context machine learning model to output the case context data,
the case context extraction prompt controls how the case context machine learning model analyzes the one or more background documents to identify key concepts therein, and
the case context data includes the identified key concepts;
generate a set of search queries based on the key concepts;
query, via a document search engine, a corpus of documents using the set of search queries to produce respective sets of ranked documents for each query in the set of search queries;
compile a seed set of documents from the respective sets of ranked documents for each query in the set of search queries; and
provide the seed set of documents to a document review application executing within a workspace.

2. The computer system of claim 1, wherein:
the set of search queries generated from the key concepts included in the case context data include multi-dimensional vectors, and
the document search engine includes a vector search engine that ranks vectorized versions of the corpus of documents by similarity to each of the multi-dimensional vectors.

3. The computer system of claim 1, wherein:
the document search engine comprises a large language machine learning model or a large multimodal machine learning model, and
the set of search queries comprise at least a portion of an input prompt for the large language machine learning model.

4. The computer system of claim 1, wherein the instructions, when executed by the one or more processors, further cause the computer system to:
generate the set of search queries by inputting the case context data into a query generation engine.

5. The computer system of claim 1, wherein the seed set of documents includes a predetermined number of the set of ranked documents for each query in the set of search queries.

6. The computer system of claim 5, wherein the seed set of documents include a set of additional random documents selected from the corpus of documents.

7. The computer system of claim 1, wherein the instructions, when executed by the one or more processors, cause the computer system to:
receive user input indicating an analysis objective for the matter; and
generate the set of search queries from the case context data and the analysis objective.

8. The computer system of claim 1, wherein to generate the case context data, the instructions, when executed by the one or more processors, cause the computer system to:
receive user input indicating an analysis objective for the matter; and
update the case context extraction prompt to include an indication of the analysis objective.

9. The computer system of claim 1, wherein the case context extraction prompt includes definitions for the key concepts, locations where the key concepts are likely to occur in the one or more background documents, or rules for structuring an output format of the key concepts.

10. The computer system of claim 1, wherein the case context data includes one or more of an overview of the matter, issues present in the matter, people relevant to the matter, or relevant entities related to the matter.

11. The computer system of claim 1, wherein the document search engine is configured to search contents of the corpus of matter related documents for matches to the set of search queries.

12. The computer system of claim 1, wherein the document search engine is configured to search metadata of the corpus of matter related documents for matches to the set of search queries.

13. The computer system of claim 1, wherein the instructions, when executed by the one or more processors, cause the computer system to:
receive feedback on accuracy of the rankings applied to respective sets of ranked documents; and
update the case context extraction prompt or one or more parameters of the case context machine learning model based on the feedback.

14. The computer system of claim 1, wherein the document review application is configured to input the seed set of documents into a document review machine learning model to identify a set of key documents from among the corpus of documents.

15. The computer system of claim 1 wherein the instructions, when executed by the one or more processors, further cause the computer system to:
receive feedback on the key concepts included in the case context data output from the case context machine learning model; and
update case context extraction prompt or one or more parameters of the case context machine learning model based on the feedback.

16. A computer-implemented method comprising:
obtaining one or more background documents for a matter and a case context extraction prompt;
generating case context data by analyzing the one or more background documents via a case context machine learning model, wherein:
the case context extraction prompt is input into the case context machine learning model with the one or more background documents to cause the case context machine learning model to output the case context data,
the case context extraction prompt controls how the case context machine learning model analyzes the one or more background documents to identify key concepts therein, and
the case context data includes the identified key concepts;
generating a set of search queries from the key concepts included in the case context data output from the case context machine learning model;
querying, via a document search engine, a corpus of documents using the set of search queries to produce respective sets of ranked documents for each query in the set of search queries;
compiling a seed set of documents from the respective sets of ranked documents for each query in the set of search queries; and
providing the seed set of documents to a document review application executing within a workspace.

17. The computer-implemented method of claim 16, wherein:
the set of search queries generated from the key concepts included in the case context data include multi-dimensional vectors, and
the document search engine includes a vector search engine that ranks vectorized versions of the corpus of documents by similarity to each of the multi-dimensional vectors.

18. The computer-implemented method of claim 16, further comprising:
generating the set of search queries by inputting the case context data output from the case context machine learning model into a query generation engine.

19. The computer-implemented method of claim 16, further comprising:
receiving feedback on accuracy of the rankings applied to respective sets of ranked documents; and
updating the case context extraction prompt or one or more parameters of the case context machine learning model based on the feedback.

20. The computer-implemented method of claim 16, wherein the document review application is configured to input the seed set of documents into a document review machine learning model to identify a set of key documents from among the corpus of documents.

21. The computer-implemented method of claim 16 further comprising:
receiving feedback on the key concepts included in the case context data output from the case context machine learning model; and
updating case context extraction prompt or one or more parameters of the case context machine learning model based on the feedback.

22. A non-transitory machine-readable medium comprising a plurality of machine-readable instructions that when executed by one or more processors are adapted to cause the one or more processors to:
obtain one or more background documents for a matter and a case context extraction prompt;
generate case context data by analyzing the one or more background documents via a case context machine learning model, wherein:
the case context extraction prompt is input into the case context machine learning model with the one or more background documents to cause the case context machine learning model to output the case context data,
the case context extraction prompt controls how the case context machine learning model analyzes the one or more background documents to identify key concepts therein, and
the case context data includes the identified key concepts;
generate a set of search queries from the key concepts included in the case context data output from the case context machine learning model;
query, via a document search engine, a corpus of documents using the set of search queries to produce respective sets of ranked documents for each query in the set of search queries;
compile a seed set of documents from the respective sets of ranked documents for each query in the set of search queries; and
provide the seed set of documents to a document review application executing within a workspace.
